(19) United States
(12) Patent Application Publication
(10) Pub. No.: US 2001/0021024 A1
(43) Pub. Date: Sep. 13, 2001

(54) Method and apparatus for fourier transform spectrometry

(76) Inventors: Mary Bliss, West Richland, WA (US); Richard A. Graig, West Richland, WA (US); Norman C. Anheier, Richland, WA (US)

Correspondence Address: Intellectual Property Services, Battelle Memorial Institute, Pacific Northwest Division, P.O. Box 999, Richland, WA, 99352, US

(21) Appl. No.: 09/826,999

(22) Filed: Apr. 4, 2001

Related U.S. Application Data
(63) Continuation-in-part of application No. 09/058,717, filed on Apr. 10, 1998.

(51) Int. Cl. G01B 9/02

(52) U.S. Cl. 356/451

(57) ABSTRACT

The present invention is an apparatus for Fourier transform spectrometry using a fixed or non-scanning interferometer wherein a pair of separated phase related electromagnetic or radiant sources produce an interference pattern that is detected and converted into its respective spectral content by a stationary converter. One application for this apparatus includes analyzing signal from a Bragg fiber-grating sensor. When coupled to a Bragg fiber-grating sensor this apparatus forms the basis of a wavelength demodulator. This demodulator converts optical frequencies down to electrical frequencies that can be readily measured with an electronic converter. This fixed interferometer has no moving parts, which greatly reduces its complexity and cost compared to a scanning interferometer.

This invention was made with Government support under Contract DE-AC0676RLO1830 awarded by the U.S. Department of Energy. The Government has certain rights in the invention.

### FIELD OF THE INVENTION

The present invention is a method and apparatus for Fourier transform spectrometry.

### BACKGROUND OF THE INVENTION

Spectrometry is the practice of the measurement of the energy of radiation. For electromagnetic radiation with wavelengths in the range between and including the ultraviolet and the infrared, commonly referred to as light, two types of spectrometry are practiced: dispersive spectrometry and Fourier-transform spectrometry. In dispersive spectrometry, the light is passed onto an optical element, commonly a prism or grating, which separates the various wavelengths; these separated wavelengths are then passed to a detector or detectors for measurement of intensity. In Fourier-transform spectrometry, the light is passed onto an interferometer and thence to a detector, which effectively returns a Fourier transform of the light intensity; in current practice, the interferometer is a Michaelson or Michaelson-like interferometer, which has a moving mirror and returns the Fourier transform as amplitude vs mirror position, which, because the mirror is moving at a constant rate, the instrument interprets as an amplitude vs time.

Presently, the primary use of spectrometry is for the measurement of the absorptive properties of liquid, solid and gaseous materials, for chemical analysis, to determine the physical properties of the materials, or to study physical processes. The present state-of-the-art of commercial Fourier spectrometers is an expensive instrument that, because of the moving mirror, is intrinsically delicate. Ruggedized moving-mirror spectrometers are available but these are even more costly. If a Fourier-transform spectrometer could be more economically fabricated it would find application in many areas of commerce, including, but not restricted to, measurement of the quality of liquid and gaseous effluents. The study of time-dependent phenomena using a moving-mirror Fourier spectrometer is complicated and requires careful and elaborate mechanisms for preserving time relationships between successive measurements (Matsutani, U.S. Pat. No. 5,251,008, issued Oct. 5, 1993). Thus, there is a need for an inexpensive, rugged Fourier transform spectrometer that does not depend upon a moving mirror.

Fiber Bragg-grating sensors are useful for monitoring the integrity of civil structures including, but not limited to, bridges and dams. A fiber Bragg grating is simply a periodic refractive index in a fiber optic core. A periodic refractive index may be achieved with a geometric corrugation of refractive index. The wavelength of the electromagnetic energy reflected from the Bragg grating changes upon a change in length (compression or expansion) of the Bragg grating. Multi-frequency electromagnetic energy is transmitted through the fiber optic to the Bragg grating(s). The frequency or frequencies reflected from the Bragg grating is/are measured and determined in a demodulator providing an indication of the amount of deformation or strain of each Bragg grating. The demodulator converts electromagnetic frequencies down to electrical signals that can be readily measured with electronic devices. Required wavelength precisions are on the order of a few parts per million to a few 10s of a part per million.

One demodulator presently used is a scanning interferometer (for example Ferret II, Research International, Woodinville, Wash.) having precision mounted mirrors that are precision scanned to distinguish the frequencies of reflected light. The associated electronics provided with the Ferret II permit obtaining an output of reflected light intensity versus wavelength.

The cost of producing optical fibers with Bragg gratings is on the order of pennies per grating whereas the cost for a scanning interferometer is many thousands of dollars (about $20,000.00). The current high cost of wavelength demodulation tends to restrict the development of fiber grating sensor applications. Thus, there is a need for a demodulator for reading out a reflected signal that does not require the precision workmanship or the cost thereby enabling greater commercial use of fiber-grating technology.

### SUMMARY OF THE INVENTION

In accordance with the present invention, a non-scanning interferometer for spectral analysis, comprising a fixed real radiant source and a fixed virtual radiant source separated by a known distance, said known distance fixed during a measurement, said fixed real radiant source and said fixed virtual radiant source having a phase relationship that produces an interference pattern, a non-scanning detector that spatially measures the interference pattern; and a non-scanning converter that converts the interference pattern into a spectral content.

Also in accordance with the present invention is a method of Fourier Transform spectrometry, comprising the steps of: providing a first fixed electromagnetic energy source and a second fixed electromagnetic energy source, said electromagnetic energy sources having a phase relationship, wherein said second fixed electromagnetic energy source is virtual; interfering electromagnetic energy output from said first and second fixed electromagnetic energy sources, thereby producing an interference pattern in the spatial domain; measuring the interference pattern; and transforming the interference pattern into a spectral content.

Also in accordance with the present invention is a fixed or non-scanning interferometric spectrometer wherein a plurality of electromagnetic energy or radiant sources that are separated or spaced apart, and phase-related, produce an interference pattern in the spatial domain that is detected and converted into its respective spectral content by a stationary converter.

The fixed interferometer of the present invention has no moving parts, which greatly reduces its complexity and cost compared to a scanning interferometer.

It is an object of the present invention to provide a fixed interferometer of a plurality of electromagnetic energy sources in combination with a fixed converter.

It is another object of the present invention to provide a method of Fourier transform spectrometry that utilizes a fixed interferometer in a manner such as to observe time-dependent phenomena.

It is another object of the present invention to combine a fixed interferometer with at least one Bragg grating for strain measurements.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### DESCRIPTION OF THE DRAWINGS

FIG. 1a is a schematic of the fixed spectrometer of the present invention with two actual electromagnetic energy sources and an optoelectronic transducer.

FIG. 1b is a schematic of the fixed spectrometer of the present invention with a Lloyd's mirror (one actual light source and a virtual light source) and an optoelectronic transducer.

FIG. 1c is a schematic of the fixed spectrometer of the present invention with a cylindrical mirror and an optoelectronic transducer.

FIG. 1d is a schematic of the fixed spectrometer of the present invention with two mirrors, forming a configuration with a plurality of phase-related sources (one actual light source and a plurality of virtual light sources), together with an optoelectronic transducer.

FIG. 1e is a schematic of the fixed spectrometer of the present invention with a conical mirror, forming a configuration with a plurality of phase-related sources (one actual light source and a plurality of virtual light sources), together with an optoelectronic transducer.

FIG. 1f is a schematic of the fixed spectrometer of the present invention in a planar waveguide mode with a single reflecting line, forming a two-dimensional Lloyd's mirror configuration with a plurality of phase-related sources (one actual light source and one virtual light source), together with an optoelectronic transducer.

FIG. 1g is a schematic of the fixed spectrometer of the present invention in a planar waveguide mode with two reflecting lines forming a configuration with a plurality of phase-related sources (one actual light source and a plurality of virtual light sources), together with an optoelectronic transducer.

FIG. 1h is a schematic of the electronics of the fixed spectrometer of the present invention operated such as to study time-dependent phenomena.

FIG. 2a is a schematic of the demodulator of the present invention combining the fixed spectrometer with an electromagnetic radiator and an electromagnetic splitter.

FIG. 2b is a schematic of the demodulator of the present invention combining the fixed spectrometer with a Bragg grating.

FIG. 2c is a schematic of the demodulator of the present invention combining the fixed spectrometer with an electromagnetic splitter and a Bragg grating.

FIG. 3a is a schematic of a material tester of the present invention wherein an object is placed between the electromagnetic energy sources and the optoelectronic transducer.

FIG. 3b is a schematic of a material tester of the present invention wherein an object is placed between an electromagnetic radiator and the electromagnetic energy sources.

FIG. 3c is a schematic of a material tester of the present invention wherein the object is a coating on a substrate.

FIG. 3d is a schematic of a material tester using a cylindrical mirror with a coating.

FIG. 4 is a schematic of a dispersive fixed spectrometer of the present invention wherein a disperser is placed between the electromagnetic energy source(s) and the optoelectronic transducer.

### DESCRIPTION OF THE PREFERRED EMBODIMENT(S)

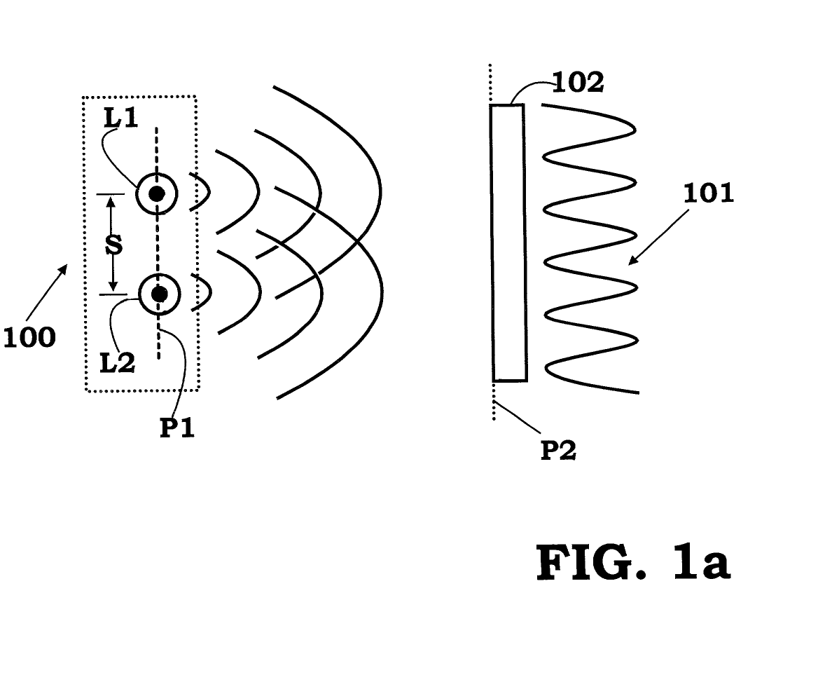

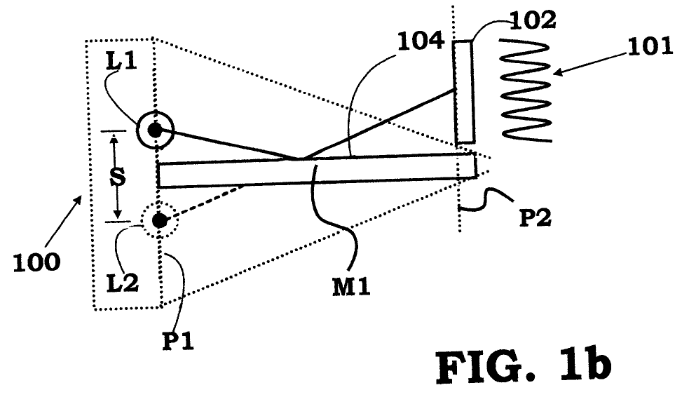

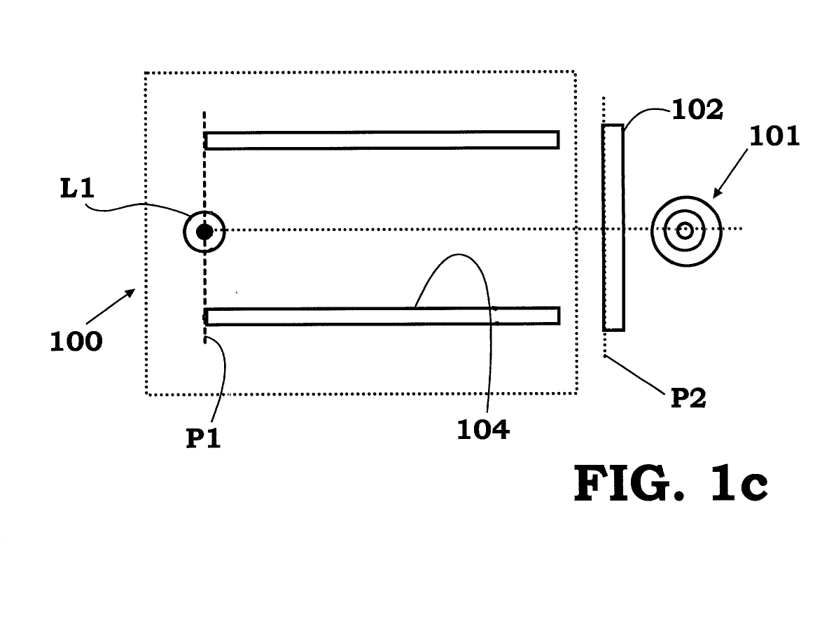

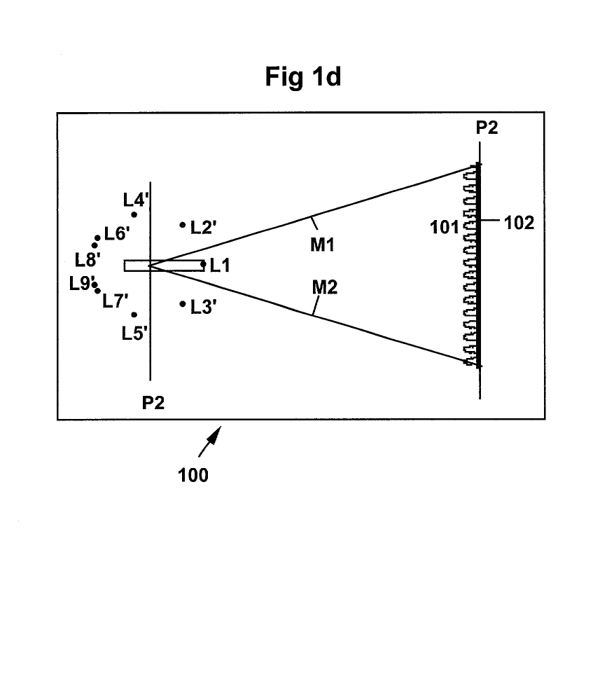

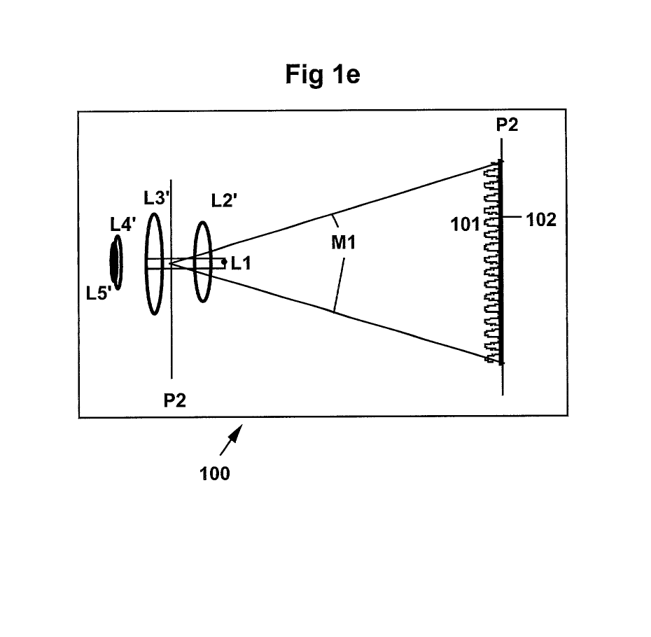

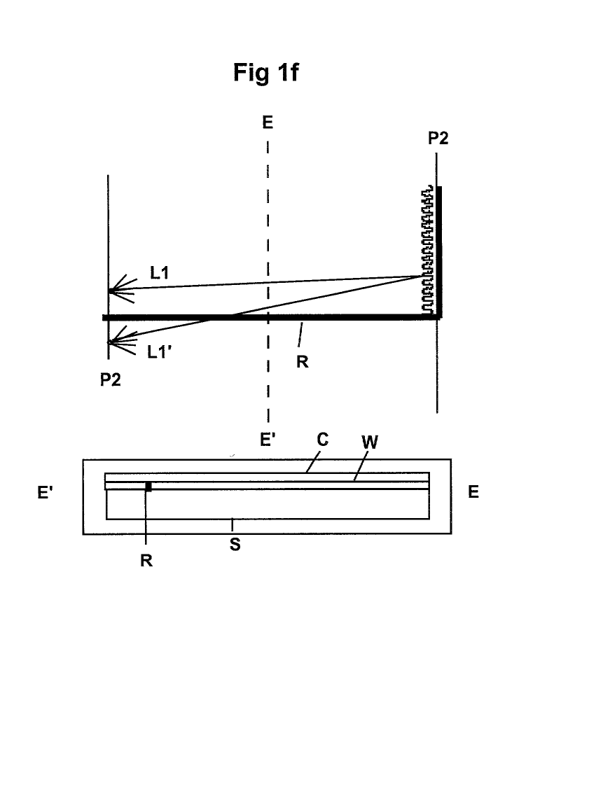

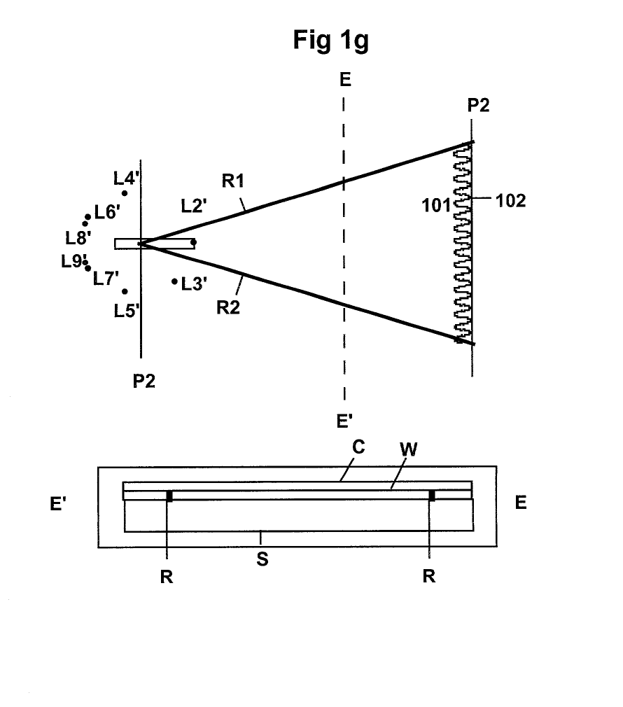

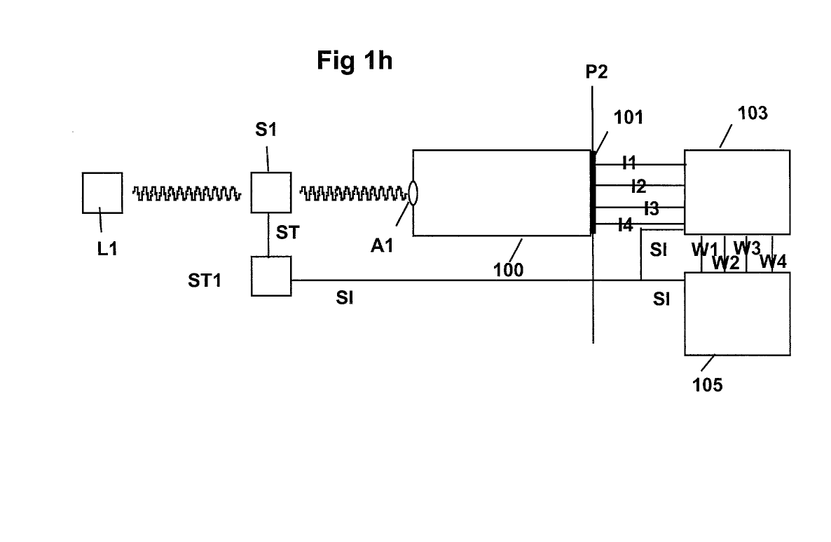

In its most general sense, the invention of a fixed spectrometer is a combination of a fixed interferometer and a fixed detector. FIG. 1a shows a first electromagnetic energy source or radiant source L1 and a second electromagnetic energy source or radiant source L2 located on a proximal plane P1, separated by a fixed distance S and having a defined relationship as a fixed interferometer 100. Electromagnetic energy propagating from the two sources L1 and L2 travel different distances to most locations on a distal plane P2 thereby creating an interference pattern 101 in the spatial domain at the distal plane P2. The fixed detector 102 detects the interference pattern 101. The fixed detector 102 is an optoelectronic transducer. The interference pattern 101 detected is related to the wavelength(s) of the light from the two sources. The interference pattern 101 is electromagnetic energy intensity versus spatial position. The space or volume between the proximal plane P1 and the distal plane P2 must be transparent to the electromagnetic energy and may be vacuum, gas, liquid, solid or a combination thereof and may have linear or non-linear optical properties.

FIG. 1b shows a first source electromagnetic energy source or radiant source L1 and a second virtual electromagnetic energy source or radiant source L2′, the latter arising as a result of reflection off the reflective surface 104 of the mirror M1, located on a proximal plane P1, separated by a fixed distance S and having a defined phase relationship as a fixed interferometer 100. Electromagnetic energy propagating from the two sources L1 and L2 travel different distances to most locations on a distal plane P2 and L2′ is phase-shifted, relative to that of L1, and thereby creating an interference pattern 101 in the spatial domain at the distal plane P2. The Interference pattern 101 is detected by the fixed detector 102. The fixed detector 102 is an optoelectronic transducer. In this embodiment, the optoelectronic transducer 102 “sees” half of the interference pattern 101 compared to that of FIG. 1a. The interference pattern 101 detected is related to the wavelength(s) of the light from the two sources. The interference pattern 101 is electromagnetic energy intensity versus spatial position. The space or volume between the proximal plane P1 and the distal plane P2 must be mostly transparent over the spectral region of interest to the electromagnetic energy and may be vacuum, gas, liquid, solid or a combination thereof and may have linear or non-linear optical properties.

FIG. 1c illustrates a spectrometer embodiment wherein the mirror 104 is cylindrical providing an interference pattern 101 that is circular and detected by the fixed detector 102. The electromagnetic energy source L1 is reflected by the reflective surface 104 which may be a material interface providing internal reflection of the electromagnetic energy.

FIG. 1d shows a first source electromagnetic energy source or radiant source L1 and a plurality of virtual electromagnetic energy sources or radiant sources L2′, L3′, etc. the latter arising as a result of repeated reflection off the mirrors M1 and M2, having a defined phase relationship as a fixed interferometer 100. Electromagnetic energy propagating from the two sources L1, L2′, L3′, etc. travel different distances to most locations on a distal plane P2 and L2′, L3′, etc. are phase-shifted, relative to that of L1 and each other, thereby creating an interference pattern 101 in the spatial domain at the distal plane P2. The interference pattern 101 is detected by the fixed detector 102. The fixed detector 102 is an optoelectronic transducer. The interference pattern 101 detected is related to the wavelength(s) of the light from the several sources. The interference pattern 101 is electromagnetic energy intensity versus spatial position and is not a simple Fourier transform of the spectrum. Because of the multitude of sources, this configuration is more sensitive to the wavelength of the radiation than that with a single source. The space or volume between the proximal plane P1 and the distal plane P2 must be transparent to the electromagnetic energy and may be vacuum, gas, liquid, solid or a combination thereof and may have linear or non-linear optical properties. Alternatively, the space or volume between the proximal plane P1 and the distal plane P2 may be defined by the material whose electromagnetic radiation interaction properties are being measured.

FIG. 1e shows a first source electromagnetic energy source or radiant source L1 and a plurality of virtual electromagnetic energy sources or radiant sources L2′, L3′, etc. effectively arranged in rings around the conical mirror, the latter arising as a result of repeated reflection off the mirrors M1 and M2, having a defined phase relationship as a fixed interferometer 100. Electromagnetic energy propagating from the two sources L1, L2′, L3′, etc. travel different distances to most locations on a distal plane P2 and L2′, L3′, etc. are phase-shifted, relative to that of L1 and each other, thereby creating an interference pattern 101 in the spatial domain at the distal plane P2. The interference pattern 101 is detected by the fixed detector 102. The fixed detector 102 is an optoelectronic transducer. The interference pattern 101 detected is related to the wavelength(s) of the light from the several sources. The interference pattern 101 is electromagnetic energy intensity versus spatial position and is not a simple Fourier transform of the spectrum. Because of the multitude of sources, this configuration is more sensitive to the wavelength of the radiation than that with a single source. The space or volume between the proximal plane P1 and the distal plane P2 must be transparent to the electromagnetic energy and may be vacuum, gas, liquid, solid or a combination thereof and may have linear or non-linear optical properties. Alternatively, the space or volume between the proximal plane P1 and the distal plane P2 may be the material whose electromagnetic radiation interaction properties are being measured.

FIG. 1f is a schematic of the fixed spectrometer of the present invention in a planar waveguide mode with a single reflecting line, forming a two-dimensional Lloyd's mirror configuration with a plurality of phase-related sources (one actual light source and a one virtual light source), together with an optoelectronic transducer. The space or volume between the proximal plane P1 and the distal plane P2 must be transparent to the electromagnetic energy and may be liquid or solid or a combination thereof and may have linear or non-linear optical properties and must be arranged in such as way as to form a planar waveguide. Alternatively, one or all of the materials forming the planar waveguide may be the material whose electromagnetic radiation interaction properties are being measured.

FIG. 1g shows the same configuration as FIG. 1d except that, in the region between the proximal plane P1 and the distal plane P2, the propagation is within a planar waveguide such that the geometry is two-dimensional. The space or volume between the proximal plane P1 and the distal plane P2 must be transparent to the electromagnetic energy and may be liquid or solid or a combination thereof and may have linear or non-linear optical properties and must be arranged in such as way as to form a planar waveguide. Alternatively, one or all of the materials forming the planar waveguide may be the material whose electromagnetic radiation interaction properties are being measured.

FIG. 1h shows the radiant source of energy L1 incident upon the sample S1, and thence onto the aperture, A1, of the interferometer, 100. The fixed detector array, 101, at the distal plane of the interferometer, P2, converts the interference pattern into a plurality of electrical signals representing the intensity as a function of position on P2; the analyzer, 103, converts this plurality of position signals into an equal plurality of wavelength amplitudes, W1, W2, W3, etc. This analysis is performed cyclically at time intervals, τ, that are convenient for the experiment and that may depend on the light intensity, the saturation properties of the detector array and other physical attributes of the detector system. The stimulus generator, ST1, generates a time datum that, after an appropriate delay, causes a stimulus to be imposed onto the sample, S1; provides a signal to the data logger, 105, that such a stimulus will occur, alerting the logger to collect data; and provides a signal to the analyzer, 103, that such a stimulus will occur such that the detector arrays are reset to a null values. The analyzer then measures, and the logger collects, the transmission, for each wavelength, W1, W2, W3, etc, of the sample for successive time intervals, 0 to τ, τ to 2τ, 2τ to 3τ, and so on. If the instrument users desires to improve the signal-to-noise ratio of the data so obtained, that is simply possible by repeating the time datum at intervals much greater than τ and greater than the time for which the sample returns to its original state. It will be apparent to one skilled in the use of optical measurements that this arrangement is representative of possible schemes for making time-dependent measurements and many alternative such arrangements are possible. It will also be apparent to one skilled in these measurements that the use of the static interferometer, greatly simplifies the measurements, compared to the means employed by Masutani. Electromagnetic energy is herein defined as energy characterized as waves having the same speed of about 3(10⁵) km/sec in free space including but not limited to power waves, radio waves, microwaves, infrared waves, visible waves, ultraviolet waves, X-ray waves, and gamma ray waves. A preferred embodiment is designed to operate with infrared or visible waves.

The fixed detector 102 or optoelectronic transducer converts electromagnetic or radiant energy into an electrical signal. Such detectors will vary according to the desired wavelength(s) to be measured. A preferred fixed detector 102 is an optoelectronic transducer for operation with infrared or visible waves and may be a linear or planar array of optical transducer elements. Such transducers are available commercially from Hamamatsu Corporation, Bridgewater, N.J.

The electromagnetic energy sources L1, L2, L2′, L3′, etc. are “point” sources understood by those of skill in the art of optics to have a variety of structures. The actual source(s) L1, L2, L2′, L3′, etc. may be pinhole(s) or slit(s) through an opaque material with an electromagnetic radiator or light behind the opaque material, wherein the electromagnetic radiator or light is any light including but not limited to reflected or focused solar or laser light, flame, thermal optical emission, chemical optical emission, and combinations thereof. Common lights include candle, electric bulb, propane lantern, etc. In one preferred embodiment, the light source(s) L1, L2, L2′, L3′, etc. is/are end(s) of an optical fiber.

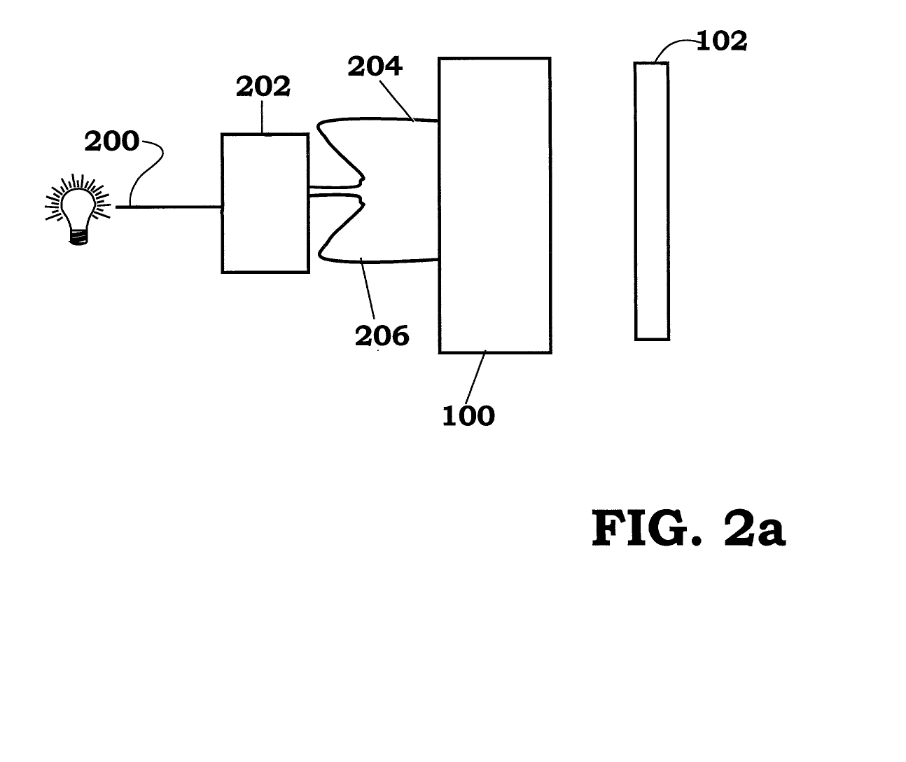

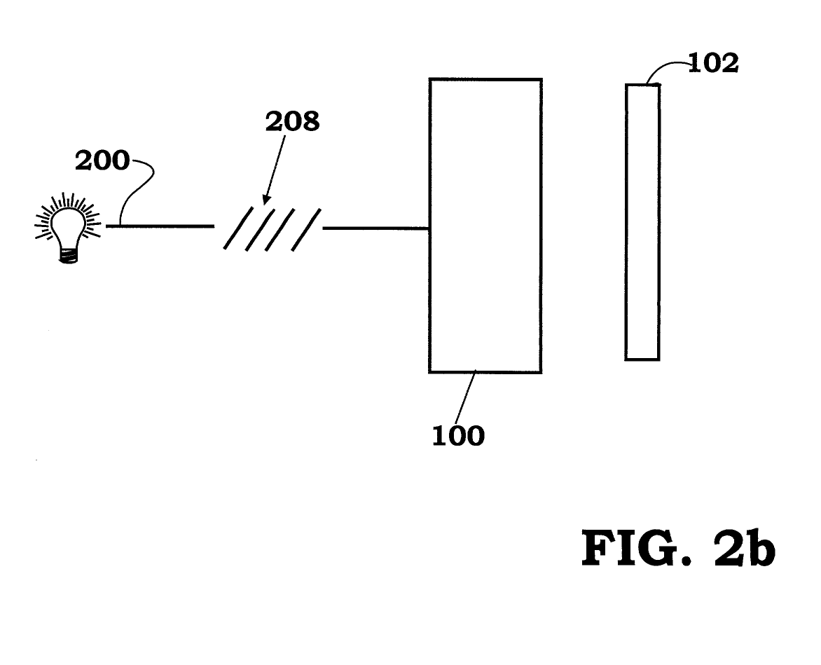

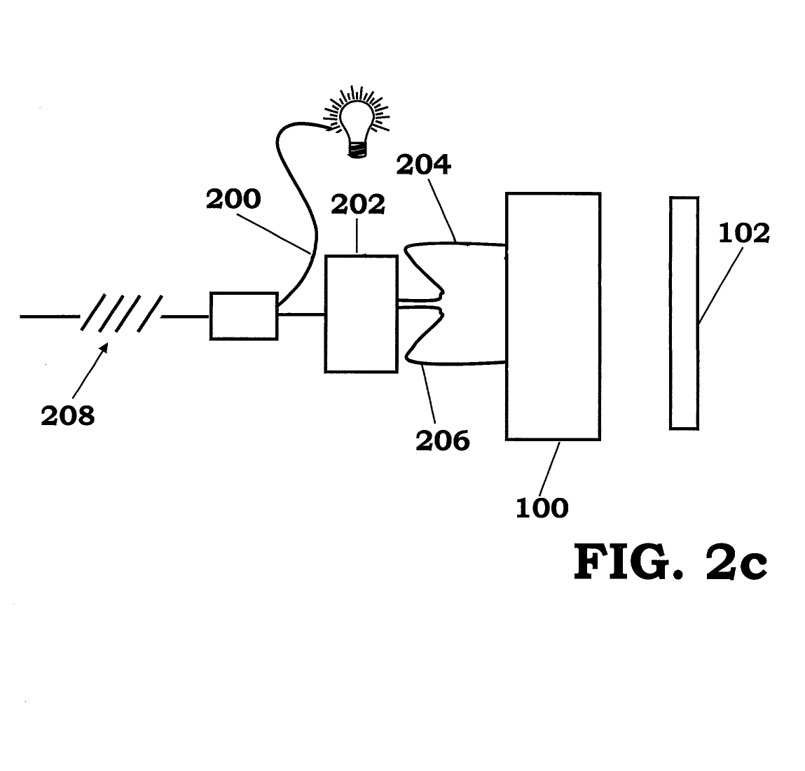

When optical fibers are used for the sources L1, L2, the sources L1, L2 can be from separate electromagnetic radiators or lights or from the same radiator or light. FIG. 2a illustrates an embodiment wherein a single radiator provides electromagnetic energy into a receiving optical fiber 200 through an optical splitter 202 and thence into source optical fibers 204, 206 of differing lengths.

A preferred embodiment of a Bragg grating demodulator is shown in FIG. 2b and FIG. 2c wherein at least one Bragg grating 208 is present in the receiving optical fiber 200. As a Bragg grating 208 is strained, its optical properties change so that the wavelength(s) of light either transmitted or reflected changes compared to the unstrained condition.

In FIG. 2b, the transmitted light is measured whereas in FIG. 2c, the reflected light is measured.

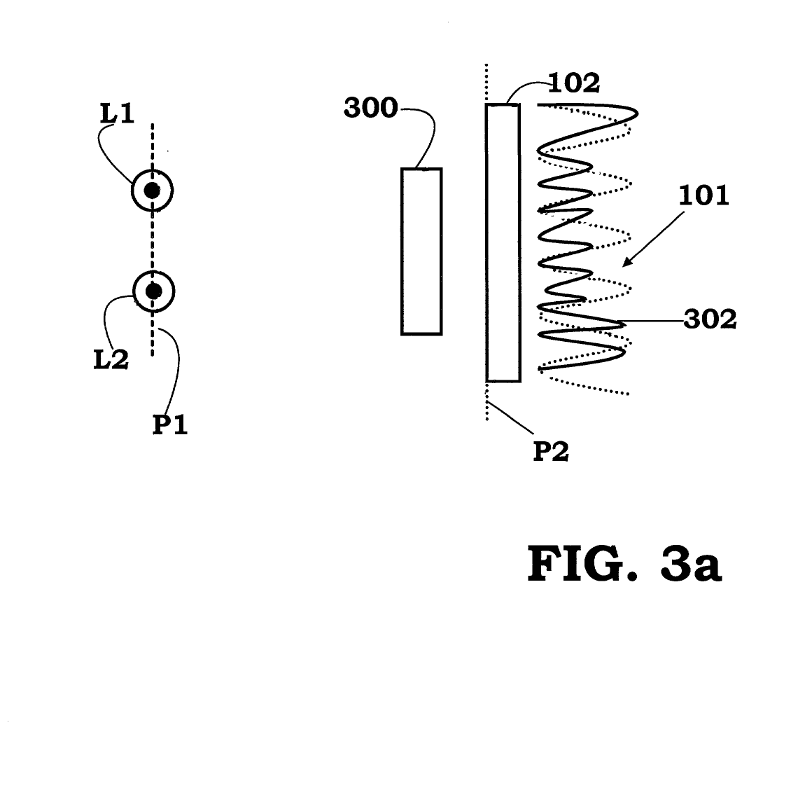

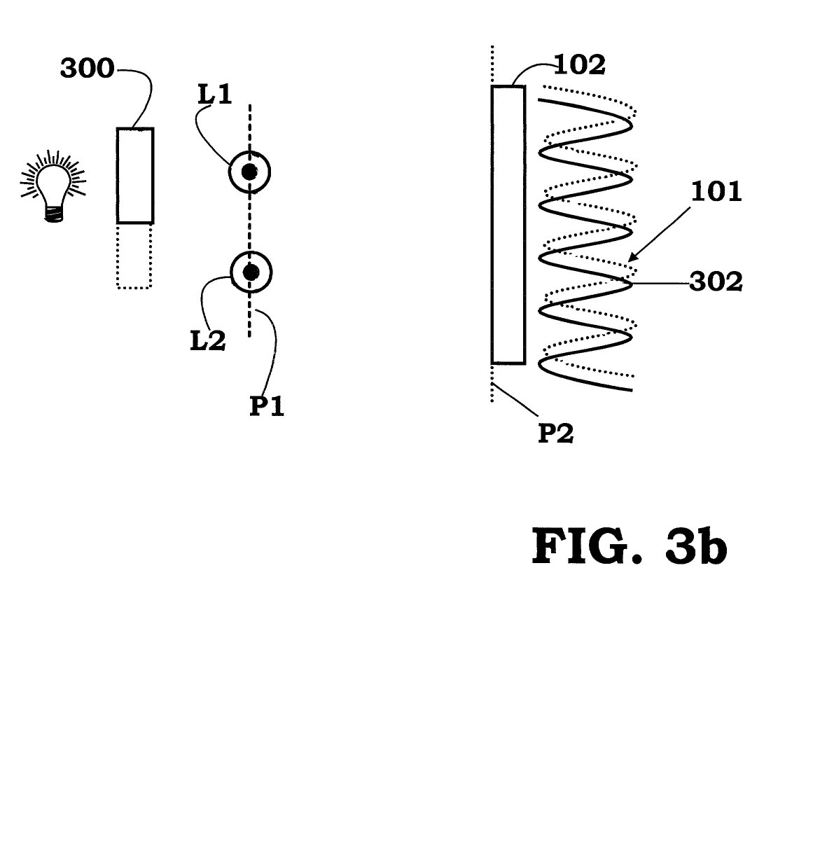

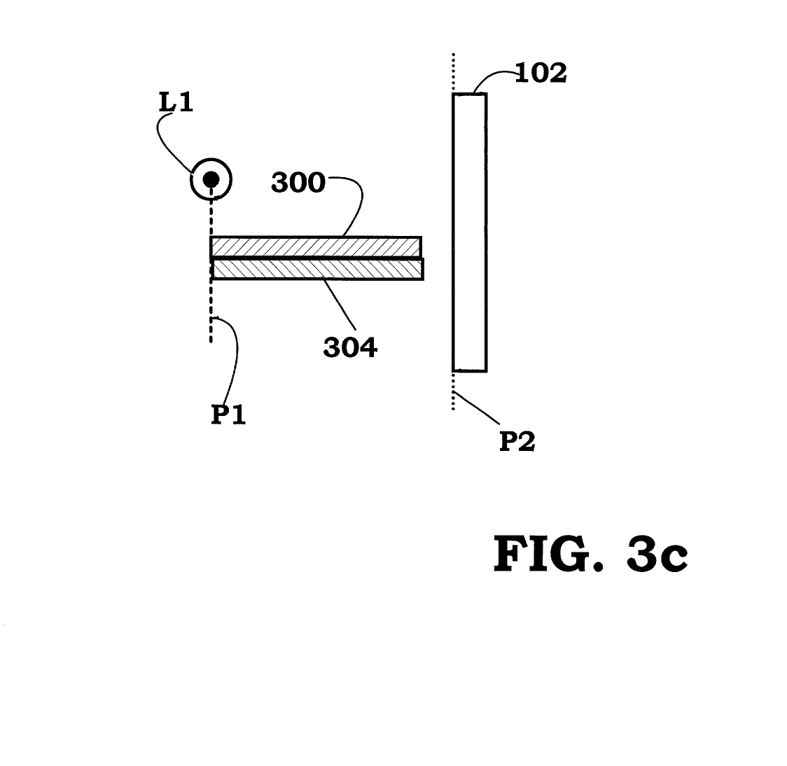

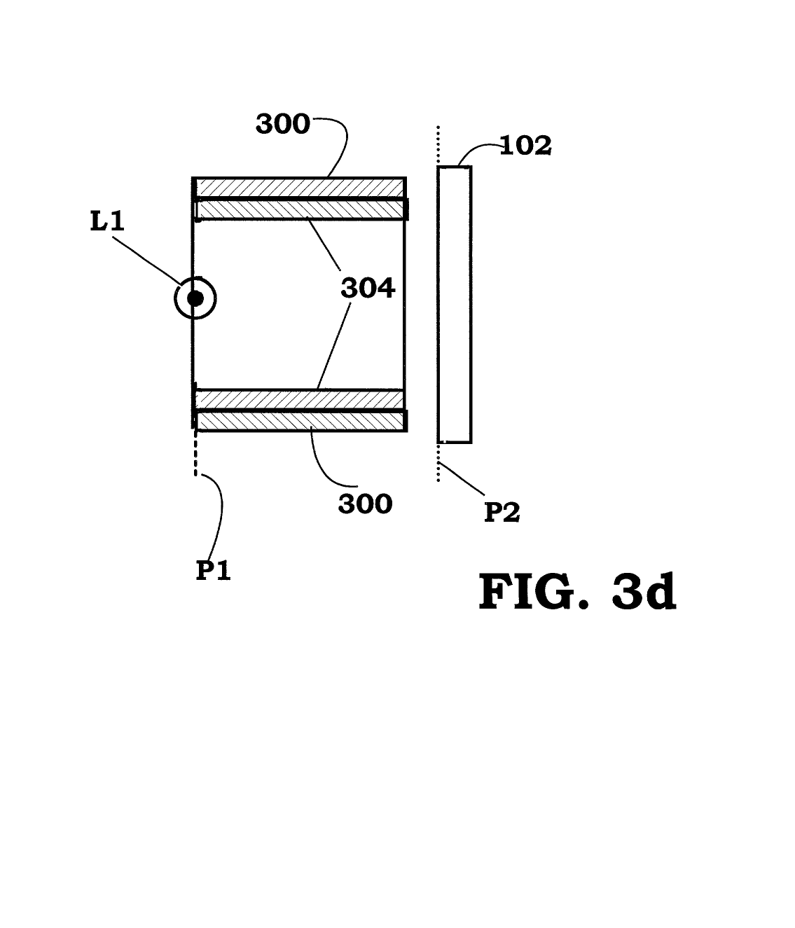

Measurement of optical properties of materials and coatings may be accomplished as illustrated in FIG. 3a, FIG. 3b, FIG. 3c, and FIG. 3d. Generally, an object 300 may be placed anywhere in an optical path between a light and the optoelectronic transducer. For example, the object 300 may be between the proximate plane P1 and the distal plane P2 as shown in FIG. 3a. Alternatively, the object 300 may be placed between a light and the proximate plane P1. To the extent that the object 300 transmits light, an altered interference pattern 302 will be measured. The object 300 may also be placed between a light and a receiving optical fiber 200 (not shown). The object 300 may intersect light to or from one or both light sources L1, L2 (FIG. 3b). Finally, the object 300 may be a coating on a substrate 304. The substrate 304 may be planar (FIG. 3c) or cylindrical (FIG. 3d), and may be optically reflective as the mirror 104 or non-optically reflective.

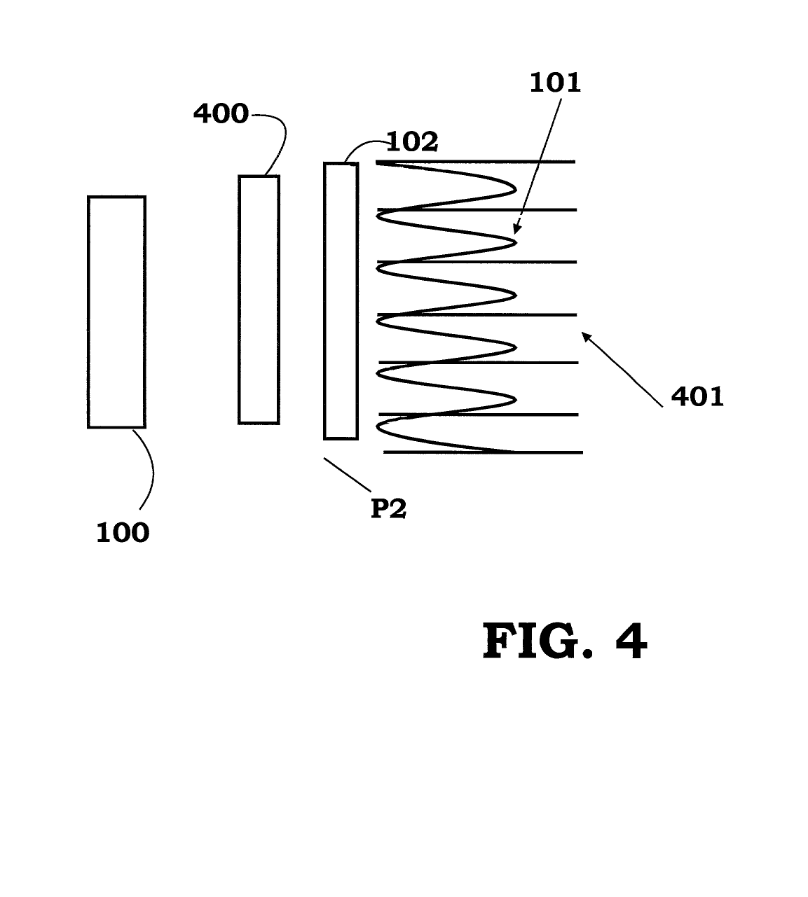

An enhancement of interference pattern measurement is shown in FIG. 4 wherein an optical disperser 400 is, placed in front of the optoelectronic transducer 102 transforming the interference pattern 101 into a dispersed interference pattern 401. The optical disperser 400 may be a prism, grating, lens or combination thereof.

The optoelectronic transducer 102 is connected to a computer (not shown) wherein the interference pattern 101 or dispersed interference pattern 401 is analyzed. The term “interference pattern” without a reference numeral is inclusive of interference pattern 101 and dispersed interference pattern 401. Data analysis is performed in the same manner as when the data are obtained from a scanning demodulator. A typical data analysis is by discrete implementation of the Fourier transform to map the digital signal from the acquired interference pattern into its Fourier series coefficients or harmonics. Each periodic signal contained in the spatial interference pattern data is simultaneously transformed into its corresponding harmonic spectrum. In the case of a plurality of sources, the analysis may be achieved by comparing interference patterns with standard patterns via various statistical means, including but not limited to Chi-squared analysis.

A substantial advantage arises by summing the digital interference pattern signals. This advantage, dubbed Fellgett's advantage, says that the relative signal-to-noise ratios, all other things being equal, will be in the ratio of (M)^{1/2} where M is the number of successively sampled elements. Both the intensity spectrum magnitude and the intensity spectrum phase provide analysis details of subtle wavelength variations.

### CLOSURE

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A method of Fourier Transform spectrometry, comprising the steps of:
(a) providing a first fixed electromagnetic energy source and a second fixed electromagnetic energy source, said electromagnetic energy sources having a phase relationship, wherein said second fixed electromagnetic energy source is virtual;
(b) interfering electromagnetic energy output from said first and second fixed electromagnetic energy sources, thereby producing an interference pattern in the spatial domain;
(c) measuring the interference pattern; and
(d) transforming the interference pattern into a spectral content.

2. The method as recited in claim 1, wherein said virtual fixed electromagnetic energy source is provided by a reflective surface.

3. The method as recited in claim 2, wherein said reflective surface is planar or cylindrical.

4. The method as recited in claim 1, wherein said first fixed electromagnetic energy source and said virtual second fixed electromagnetic energy source are supplied by a light source optically demodulated by:
(a) receiving a light into an optical fiber;
(b) altering said light; and
(c) using said altered light as said first fixed electromagnetic energy source and said virtual second fixed light source.

5. The method as recited in claim 4, wherein altering said light is splitting said light.

6. The method as recited in claim 4, wherein altering said light is sending said light through a Bragg grating.

7. The method as recited in claim 1, further providing said first fixed electromagnetic energy source and said virtual second fixed electromagnetic energy source as a light source, transforming the interference pattern with an optoelectronic transducer, and optically measuring the interference pattern of a test material by placing the material between said light source and the optoelectronic transducer.

8. The method as recited in claim 1, wherein said interference pattern is altered prior to the measuring in step (c).

9. An apparatus of a non-scanning interferometer for spectral analysis, comprising:
(a) a fixed real radiant source and a fixed virtual radiant source separated by a known distance, said known distance fixed during a measurement, said fixed real radiant source and said fixed virtual radiant source having a phase relationship that produces an interference pattern;
(b) a non-scanning detector that spatially measures the interference pattern; and
(c) a non-scanning converter that converts the interference pattern into a spectral content.

10. The apparatus as recited in claim 9, wherein said non-scanning detector is linear or planar.

11. The apparatus as recited in claim 9, wherein said fixed virtual source is provided by a reflective surface.

12. The apparatus as recited in claim 11, wherein said reflective surface is planar or cylindrical.

13. The apparatus as recited in claim 9, wherein said fixed sources and said non-scanning detector define a space or volume there between selected from the group consisting of vacuum, gas, liquid, solid or a combination thereof.

14. The apparatus as recited in claim 9, wherein said fixed real radiant source and said fixed virtual radiant source receives light from an optical demodulation apparatus, comprising:
(a) an optical fiber for receiving and transmitting light;
(b) a light alteration unit that receives the light from the optical fiber and passes altered light into the pair of radiant light sources.

15. The apparatus as recited in claim 14, wherein the light alteration unit is a splitter.

16. The apparatus as recited in claim 14, wherein the light alteration unit is a Bragg grating.

17. The apparatus as recited in claim 13, wherein a disperser is placed between the pair of radiant sources and the non-scanning detector.
